(19) United States
(12) Patent Application Publication
(10) Pub. No.: US 2009/0000713 A1
(43) Pub. Date: Jan. 1, 2009

(54) TIRE INCLUDING SEGMENTED SIPES

(75) Inventor: Terrence M. Stuhldreher, Wadsworth, OH (US)

Correspondence Address: BRIDGESTONE AMERICAS HOLDING, INC., 1200 FIRESTONE PARKWAY, AKRON, OH, 44317, US

(73) Assignee: Bridgestone Firestone North American Tire, LLC

(21) Appl. No.: 11/769,130

(22) Filed: Jun. 27, 2007

(51) Int. Cl. B60C 11/12

(52) U.S. Cl. 152/209.24; 425/28.1

(57) ABSTRACT

A tire having a circumferential tread with segmented sipes is provided. In one embodiment, the tire has tread blocks with sipes having at least three segments. The sipe may include a first major segment, a second major segment, and a minor segment connected to both the first major segment and the second major segment. In alternative embodiments, the sipe may include three or more major segments, connected by a plurality of minor segments.

### FIELD OF INVENTION

The present application relates to a segmented sipe of a tire tread. More particularly, the application relates to sipes having two or more major segments connected by minor segments.

### BACKGROUND

Many motor vehicle tires have a circumferential tread provided with a plurality of circumferential grooves that define ribs therebetween. Typically, generally lateral slots can be provided in the ribs to form a plurality of shaped blocks, known as tread blocks. These tread blocks can be distributed along the tread according to a specific pattern. Sipes, which are generally narrow slits cut into the tread, can be provided in the tread blocks to improve wet, snow, and ice traction of the tire.

### SUMMARY

In one embodiment of the application, a tire having a circumferential tread with segmented sipes is provided. The tire may have tread blocks with sipes having at least three segments. The sipe may include at least two major segments, including a first major segment and a second major segment. The sipe may further include at least one minor segment extending from the first major segment to the second major segment. In other known embodiments, the sipe may include three or more major segments, connected by a plurality of minor segments.

### BRIEF DESCRIPTION OF DRAWINGS

In the accompanying drawings, tires and tread patterns are illustrated that, together with the detailed description provided below, describe exemplary embodiments of the claimed invention.

In the following drawings and description, like elements are identified with the same reference numerals. The drawings are not to scale and the proportion of certain elements may be exaggerated for the purpose of illustration.

FIG. 1 illustrates a tire having a circumferential tread with blocks having straight sipes as viewed from the top surface of the tire;

FIG. 2 illustrates a prior art tread block having a straight sipe;

FIG. 3 illustrates a perspective view of a tread block having one embodiment of a radially segmented sipe;

FIG. 3A illustrates a side planar view of a tread block having one embodiment of a radially segmented sipe;

FIG. 4 illustrates a perspective view of a tread block having one embodiment of a radially segmented sipe in a braking condition;

FIG. 5 illustrates a perspective view of a tread block having one embodiment of a radially segmented sipe in an acceleration condition;

FIG. 6 illustrates a perspective view of a tread block having an alternative embodiment of a radially segmented sipe;

FIG. 6A illustrates a side planar view of a tread block having an alternative embodiment of a radially segmented sipe;

FIG. 7 illustrates a perspective view of a tread block having an alternative embodiment of a radially segmented sipe in a braking condition;

FIG. 8 illustrates a perspective view of a tread block having an alternative embodiment of a radially segmented sipe in an acceleration condition;

FIG. 9 illustrates one embodiment of a tire having a circumferential tread with a plurality of laterally segmented sipes;

FIG. 10 illustrates a perspective view of a tread block having one embodiment of a laterally segmented sipe;

FIG. 10A illustrates a top planar view of a tread block having one embodiment of a laterally segmented sipe;

FIG. 11 illustrates a perspective view of a tread block having one embodiment of a laterally segmented sipe in a braking condition;

FIG. 12 illustrates a perspective view of a tread block having one embodiment of a laterally segmented sipe in an acceleration condition;

FIG. 13 illustrates a perspective view of a tread block having one embodiment of a segmented sipe that is segmented in two directions;

FIG. 14 illustrates a perspective view of a tread block having one embodiment of a sipe segmented in two directions in a braking condition; and

FIG. 15 illustrates a perspective view of a tread block having one embodiment of a sipe segmented in two directions in an acceleration condition.

### DETAILED DESCRIPTION

The following includes definitions of selected terms employed herein. The definitions include various examples and/or forms of components that fall within the scope of a term. The examples are not intended to be limiting. Both singular and plural forms of terms may be within the definitions.

“Axial” or “axially” refer to a direction that is parallel to the axis of rotation of a tire.

“Circumferential” and “circumferentially” refer to a direction extending along the perimeter of the surface of an annular tread perpendicular to the axial direction.

“Equatorial plane” refers to the plane that is perpendicular to the tire's axis of rotation and passes through the center of the tire's tread.

“Footprint” refers to a surface area covered by a tire in contact with the surface.

“Lateral” and “laterally” refer to a direction along a tread of a tire going from one sidewall of the tire to the other sidewall.

“Radial” and “radially” refer to a direction that is perpendicular to the axis of rotation of a tire.

“Rib” or “ribs” define the circumferential extending strip or strips of rubber on the tread that is defined by at least one circumferential groove and either a second wide groove or a lateral edge of the tread.

“Tread” refers to that portion of a tire that comes into contact with the road under a normal load.

FIG. 1 illustrates a prior art tire 100 having a circumferential tread 110 with a plurality of tread blocks 120. Each of the tread blocks 120 includes one or more sipes 130. In alternative embodiments, sipes may be disposed in ribs of a tire tread, instead of blocks. In the illustrated embodiment, the sipes 130 are straight and extend in a lateral direction. Other known prior art sipes include curved and wave-shaped sipes. Additionally, other known prior art sipes may extend circumferentially, or at an acute angle with respect to the circumferential direction of the tire.

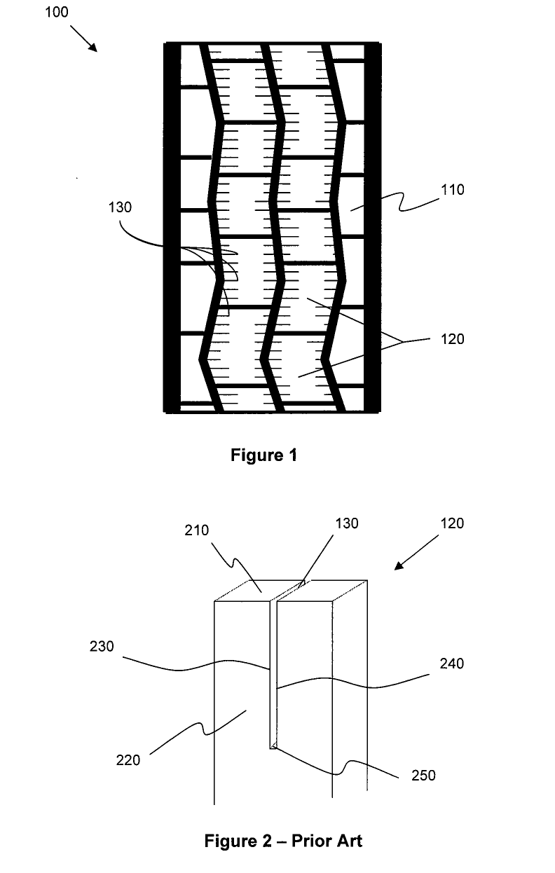

FIG. 2 illustrates a close up, perspective view of a prior art tread block 120 having a sipe 130. The block 120 may be any regular or irregular polyhedron and includes at least a top surface 210 defining a top surface of the circumferential tread 110 of the tire 100 and a side surface 220 defining a groove in the circumferential tread 110. The sipe 130 is a void in the tread block 120 defined by a plurality of walls. Specifically, the sipe 130 is defined by a first elongated wall 230 that extends radially inward from the top surface 210 of the tread block 120, forming an edge with the top surface 210 and additionally forming an edge with a side surface 220. The sipe 130 is further defined by a second elongated wall 240 that extends radially inward from the top surface 210 of the tread block 120, forming an edge with the top surface 210 and additionally forming an edge with the side surface 220. Finally, the sipe 130 is also defined by a bottom surface 250 that extends laterally from the side surface 220 of the tread block 120, forming edges with the side surface 220, the first elongated wall 230, and the second elongated wall 240. In the illustrated embodiment, the first elongated wall 230 is substantially parallel to the second elongated wall 240 and the bottom surface 250 is orthogonal to each of the first and second elongated walls 230, 240.

Although a sipe is a void defined by walls of a tread (or a tread block), it is convenient to describe a sipe as if it were a physical object. For example, in FIG. 2, the sipe 130 may be described as a straight line. It should be understood that describing a shape or a profile of a sipe is simply a shorthand way to describe a shape of a void defined by walls in a tread or tread block.

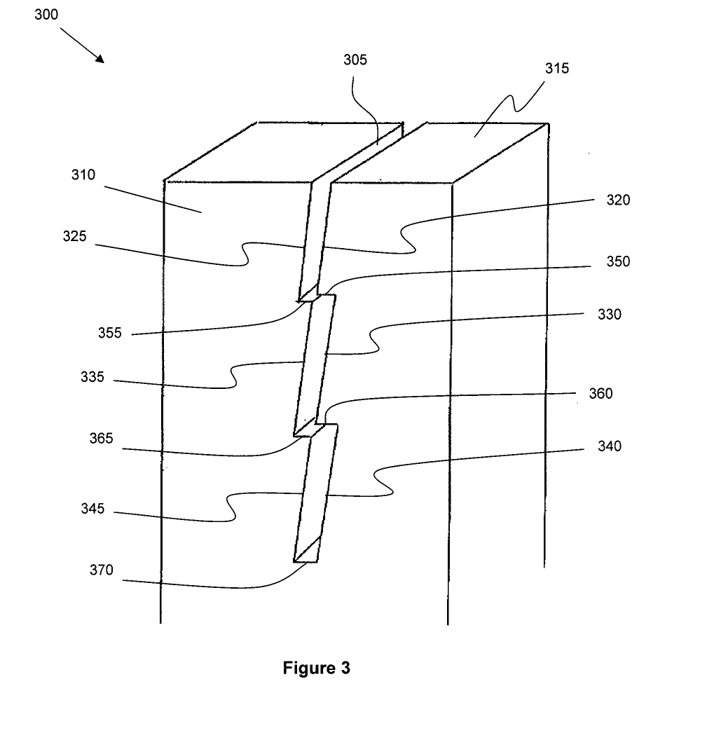

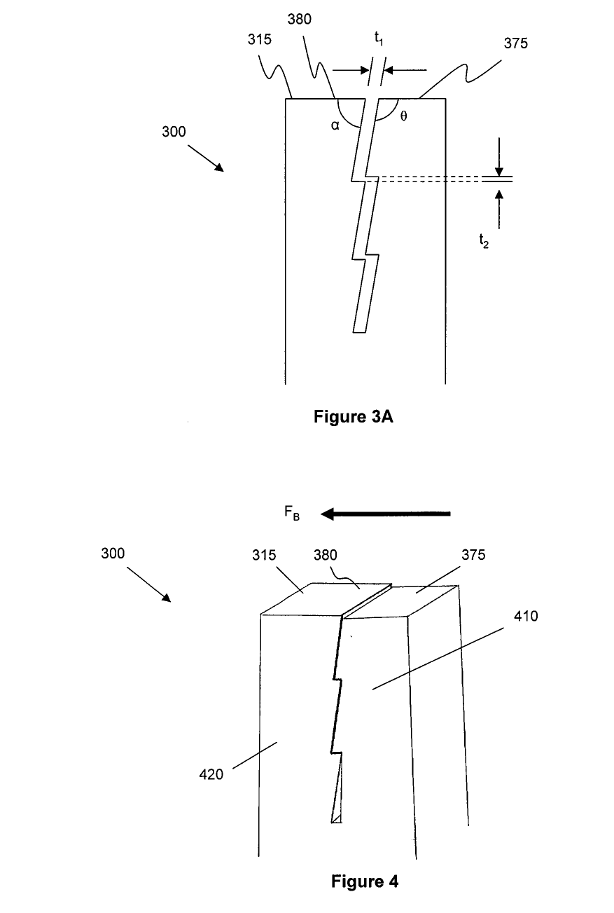

FIG. 3 illustrates a close up, perspective view of a tread block 300 having one embodiment of a radially segmented sipe 305. The tread block 300 may be any regular or irregular polyhedron and includes at least a side surface 310 defining a groove in a circumferential tread of a tire and a top surface 315 defining a top surface of the circumferential tread. The radially segmented sipe 305 is segmented in an inward direction (i.e., towards the radius of the tire). In other words, the radially segmented sipe has segmented opening as viewed from a side surface 310 of the tread block 300. It should be understood that a radially segmented sipe need not extend in a truly radial direction (i.e., perpendicular to the axis of the tire). In the illustrated embodiment, the radially segmented sipe 305 appears straight when viewed from a top surface 315 of the tread block 300. In alternative embodiments (not shown), the radially segmented sipe appears curved or angled when viewed from a top surface of the tread block.

When the tire rotates, the “top surface” 315 may be located at the side or the bottom of the tire. However, it should be understood that the terms “top” and “bottom” are used to describe orientation of the tread block as it is illustrated in FIG. 3.

The radially segmented sipe 305 is a void in the tread block 300 defined by a plurality of walls. In the illustrated embodiment, the radially segmented sipe 305 is defined by a first elongated wall 320 that extends inward from the top surface 315 of the tread block 300, thereby forming an edge with the top surface 315, and further extending laterally from the side surface 310, thereby forming an edge with the side surface 310. The radially segmented sipe 305 is further defined by a second elongated wall 325 that extends radially inward from the top surface 315 of the tread block 300, thereby forming an edge with the top surface 315, further extending laterally from the side surface 310, thereby forming an edge with the side surface 310. The radially segmented sipe 305 is further defined by a third elongated wall 330, a fourth elongated wall 335, a fifth elongated wall 340, and a sixth elongated wall 345, each of which extends laterally from the side surface 310 of the tread block 300 to form an edge with the side surface 310.

Additionally, the radially segmented sipe 305 is defined by a plurality of minor walls that connect the elongated walls, including a first minor wall 350 extending from a bottom end of the first elongated wall 320 to a top end of the third elongated wall 330; a second minor wall 355 extending from a bottom end of the second elongated wall 325 to a top end of the fourth elongated wall 335; a third minor wall 360 extending from a bottom end of the third elongated wall 330 to a top end of the fifth elongated wall 340; a fourth minor wall 365 extending from a bottom end of the fourth elongated wall 335 to a top end of the sixth elongated wall 345; and a fifth minor wall 370 extending from a bottom end of the fifth elongated wall 340 to a bottom end of the sixth elongated wall 345. As can be seen in FIG. 3, the elongated walls 320, 325, 330, 335, 340, 345 have a substantially longer length than the minor walls 350, 355, 360, 365, 370.

In the illustrated embodiment, each of the elongated walls 320, 325, 330, 335, 340, 345 are substantially parallel to each other. Similarly, each of the minor walls 350, 355, 360, 365, 370 are substantially parallel to each other. Additionally, each of the minor walls 350, 355, 360, 365, 370 are substantially parallel to the top surface 315 of the tread block 300 and are at acute angles with respect to the elongated walls 320, 325, 330, 335, 340, 345. In an alternative embodiment (not shown), the elongated walls are at acute angles with respect to each other. In another alternative embodiment (not shown), the minor walls are at acute angles with respect to each other. In yet another alternative embodiment (not shown), the minor walls are at acute angles with respect to the top surface 315 of the tread block 300.

With continued reference to FIG. 3, the sipe 305 may be described as having a segmented shape. Specifically, the sipe 305 may be described as having a “ratchet” or “lightning bolt” shape. In the illustrated embodiment, the radially segmented sipe 305 includes three major segments and two minor segments, each of which is visible when viewed from the side surface 310 of the tread block 300. In the illustrated embodiment, the first and second elongated walls 320, 325 define a first major segment, the third and fourth elongated walls 330, 335 define a second major segment, and the fifth and sixth elongated walls 340, 345 define a third major segment. Further, the first and second minor walls 350, 355 define a first minor segment having a first end connected to a bottom end of the first major segment and a second end connected to a top end of the second major segment. In other words, the first minor segment extends from the bottom of the first major segment to the top of the second major segment. Additionally, the third and fourth minor walls 360, 365 define a second minor segment having a first end connected to a bottom end of the second major segment and a second end connected to a top end of the third major segment. In other words, the second minor segment extends from the bottom of the second major segment to the top of the third major segment.

FIG. 3A illustrates a side planar view of one embodiment of the tread block 300. As can be seen in the illustrated embodiment, the first, second, and third major segments are substantially parallel to each other. In this embodiment, the radially segmented sipe forms an obtuse angle θ with a forward portion 375 of the top surface 315 of the tread block 300 and an acute angle α with a rearward portion 380 of the top surface 315 of the tread block 300. Further, the first minor segment is substantially parallel to the second minor segment. Additionally, the first and second minor segments are substantially parallel to the top surface 315 of the tread block 300 and are at acute angles with respect to the major segments. In an alternative embodiment (not shown), the first minor segment is at an acute angle with respect to the second minor segment. In another alternative embodiment (not shown), the first and second minor segments are substantially orthogonal to the major segments. In yet another alternative embodiment (not shown), the first and second minor segments are at obtuse angles with respect to the major segments. In yet another alternative embodiment (not shown), at least two of the major segments are at acute angles with respect to each other.

In the illustrated embodiment, the major segments have a substantially longer length than the minor segments. Additionally, the major segments each have substantially the same length. Similarly, the first minor segment has the same length as the second minor segment. In an alternative embodiment (not shown), at least one of the major segments has a different length from the other major segments. In another alternative embodiment (not shown), the first minor segment has a different length from the second minor segment.

When the tire is at rest, as shown in FIG. 3A, the major segments of the radially segmented sipe have a thickness t₁ and the minor segments have a thickness t₂. In the illustrated embodiment, the thickness t₁ of the first major segment is substantially the same as the second and third major segments. Further, the thickness t₂ of the first minor segment is substantially the same as the thickness of the second minor segment. In the illustrated embodiment, the thickness t₂ of the minor segments is less than the thickness t₁ of the major segments. In one embodiment, the thickness t₁ of each major segment is about 0.030 inches to about 0.060 inches and the thickness t₂ of each minor segment is about 0.008 inches to about 0.025 inches.

In an alternative embodiment (not shown), the thickness t₂ of the minor segments is equal to the thickness t₁ of the major segments. In another alternative embodiment (not shown), the thickness of at least one of the major segments is different from the thickness of another major segment. In another alternative embodiment (not shown), the thickness of the first minor segment is different from the thickness of the second minor segment.

FIG. 4 illustrates one embodiment of the tread block 300 when a braking force F_{B} is applied. With the above described configuration, the tread block 300 is configured to deform when a braking force F_{B} is applied, such that the thickness of the radially segmented sipe 305 is substantially reduced. In the illustrated embodiment, a forward portion 410 of the tread block 300 deforms and is biased towards a rearward portion 420, such that the first elongated wall 320 is moved towards the second elongated wall 325, reducing the thickness of the first major segment. Further, the third elongated wall 330 is moved towards the fourth elongated wall 335, reducing the thickness of the second major segment. Additionally, the fifth elongated wall 340 is moved towards the sixth elongated wall 345, reducing the thickness of the third major segment.

With continued reference to FIG. 4, the geometry of the radially segmented sipe 300 is such that when a braking force F_{B} is applied to the tread block 300, the tread block 300 is deformed such that the first minor wall 350 is moved towards the second minor wall 355, reducing the thickness of the first minor segment. Further, the third minor wall 360 is moved towards the fourth minor wall 365, reducing the thickness of the second minor segment.

In the illustrated embodiment, when a sufficient braking force F_{B} is applied to a tire, the first elongated wall 320 contacts the second elongated wall 325, substantially reducing the thickness of the first major segment to zero. In other words, the first major segment is eliminated. Similarly, the third elongated wall 330 contacts the fourth elongated wall 335, substantially reducing the thickness of the second major segment to zero. In other words, the second major segment is eliminated. Further, the first minor wall 350 contacts the second minor wall 355, substantially reducing the thickness of the first minor segment to zero. In other words, the first minor segment is eliminated. Similarly, the third minor wall 360 contacts the fourth minor wall 365, substantially reducing the thickness of the second minor segment to zero. In other words, the second minor segment is eliminated. It should be understood that when a lesser braking force is applied, the tread block 300 may be deformed such that the segments of the radially segmented sipe 305 are reduced without being eliminated. Further, in an alternative embodiment (not shown), the tread block 300 may be sufficiently rigid such that the segments of the radially segmented sipe 305 are never eliminated, but merely reduced.

As a result of the above, the sipe opening in the top surface 315 closes when a sufficient braking force F_{B} is applied, and the forward portion 375 of the top surface 315 is only slightly displaced with respect to the rearward portion 380 of the top surface 315. In one embodiment, the displacement of the forward portion 375 relative to the rearward portion 380 is equal to or less than the thickness t₂ of the minor segments. Because the first minor wall 350 is contacting the second minor wall 355 and the third minor wall 360 is contacting the fourth minor wall 365, the radially segmented sipe 305 is closed and the tread block 300 cannot be further deformed. In other words, the sipe is locked and the tread block 300 becomes rigid such that the forward portion 375 of the top surface 315 cannot be further displaced. Therefore, when a braking force is applied to a tire, more of the tread surface stays in contact with a road surface. This results in improved tire traction for braking, especially on a dry surface, thus reducing stopping distance.

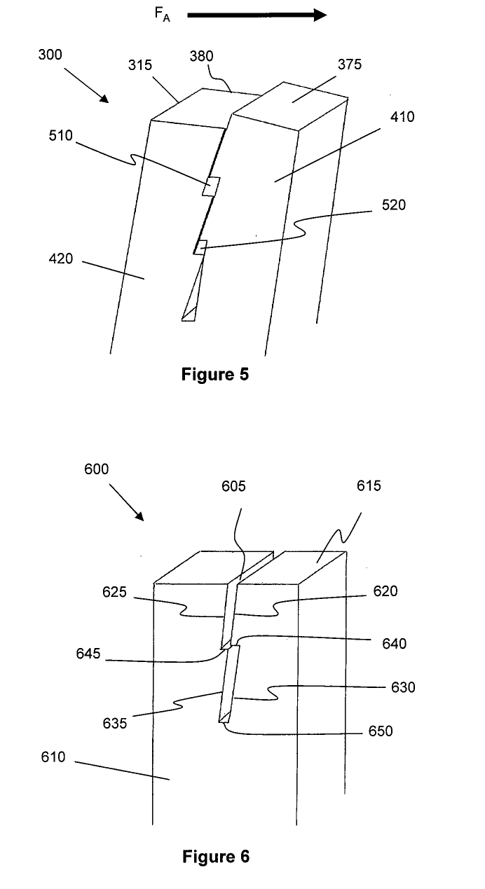

FIG. 5 illustrates one embodiment of the tread block 300 when an acceleration force F_{A} is applied to a tread block 300. The tread block 300 is configured to deform when an acceleration force F_{A} is applied, such that the radially segmented sipe 305 is not eliminated. As can be seen in the illustrated embodiment, the rearward portion 420 of the tread block 300 deforms and moves toward the forward portion 410 such that the second elongated wall 325 is moved towards the first elongated wall 320, reducing the thickness of the first major segment. Further, the fourth elongated wall 335 is moved towards the third elongated wall 330, reducing the thickness of the second major segment. Additionally, the sixth elongated wall 345 is moved towards the fifth elongated wall 340, reducing the thickness of the first major segment.

In the illustrated embodiment, when a sufficient acceleration force F_{A} is applied to a tire, the second elongated wall 325 contacts the first elongated wall 320, substantially reducing the thickness of the first major segment to zero. In other words, the first major segment is eliminated. Similarly, the third elongated wall 335 contacts the fourth elongated wall 330, substantially reducing the thickness of the second major segment to zero. In other words, the second major segment is eliminated. It should be understood that when a lesser acceleration force is applied, the tread block 300 may be deformed such that the elongated segments of the radially segmented sipe 305 are reduced, but not eliminated. Further, in an alternative embodiment (not shown), the tread block 300 may be sufficiently rigid such that the elongated segments of the radially segmented sipe 305 are never eliminated, but merely reduced.

With continued reference to FIG. 5, the geometry of the radially segmented sipe 300 is such that when an acceleration force F_{A} is applied to a tread block 300, the tread block 300 is deformed such that the rearward portion 420 of the tread block 300 biases the forward portion 410 in a forward direction. Therefore, the first minor wall 350 and the second minor wall 355 move away from each other, increasing the thickness of the first minor segment and creating a first enlarged opening 510. Further, the third minor wall 360 and the fourth minor wall 365 move away from each other, increasing the thickness of the second minor segment and creating a second enlarged opening 520. In an alternative embodiment (not shown), the geometry of the radially segmented sipe 305 may be such that the minor segments maintain the same thickness when an acceleration force is applied to a tire.

In the above described embodiment, when an acceleration force F_{A} is applied to a tire, the forward portion 375 of the top surface 315 is displaced relative to the rear portion 380. The sipe does not lock into position, so the tread block 300 has less rigidity when it is in an acceleration condition. When the acceleration force is increased, the tread block 300 is further deformed, and the displacement of the forward portion 375 is increased, thereby reducing the surface area of the tread that is exposed to a road surface. This results in improved tire traction for accelerating in snowy, wet, or other slippery conditions.

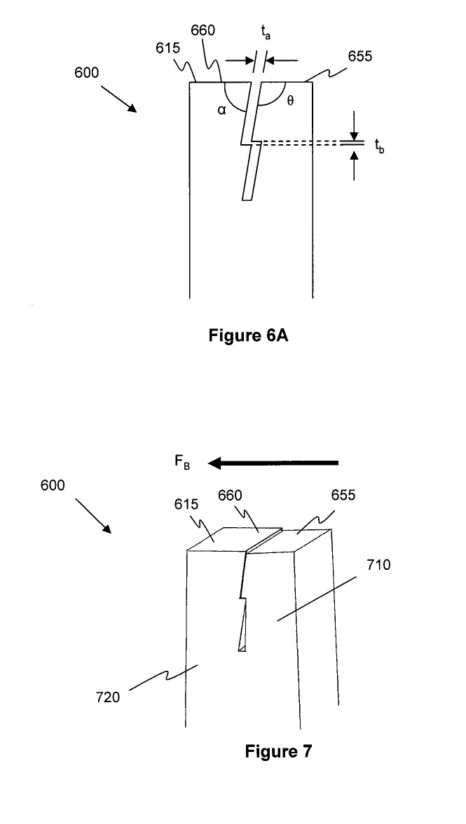

With attention now to FIG. 6, a close up, perspective view is illustrated of a tread block 600 having an alternative embodiment of a radially segmented sipe 605. The tread block 600 may be any regular or irregular polyhedron and includes at least a side surface 610 defining a groove in a circumferential tread of a tire and a top surface 615 defining a top surface of the circumferential tread. In the illustrated embodiment, the radially segmented sipe 605 is similar to the segmented sipe illustrated in FIGS. 3-5, except that it includes two major segments instead of three, and one minor segment instead of two. Specifically, the tread block 600 includes first and second elongated walls 620, 625 that define a first major segment, and third and fourth elongated walls 630, 635 that define a second major segment. Further, the tread block 600 includes first and second minor walls 640, 645 that define a minor segment having a first end connected to a bottom end of the first major segment and a second end connected to a top end of the second major segment, such that each of the segments is visible when viewed from the side surface of the tread block 600. In other words, the minor segment extends from the bottom of the first major segment to the top of the second major segment.

Additionally, the radially segmented sipe 605 includes a third minor wall 650 that has a first end connected to a bottom end of the third elongated wall 630 and a second end connected to a bottom end of the fourth elongated wall 635. The elongated walls 620, 625, 630, 635 are substantially longer than the minor walls 640, 645, 650. The illustrated tread block 600 of FIG. 6 is otherwise substantially similar to the tread block 300 of FIG. 3.

FIG. 6A illustrates a side planar view of one embodiment of the tread block 600. As can be seen in the illustrated embodiment, the first and second major segments are substantially parallel to each other. In this illustrated embodiment, the first major segment forms an obtuse angle θ with a forward portion 655 of the top surface 615 of the tread block 600 and an acute angle α with a rearward portion 660 of the top surface 615 of the tread block 600. Additionally, the minor segment is substantially parallel to the top surface 615 of the tread block 600 and is at acute angles with respect to the first and second major segments. In an alternative embodiment (not shown), the minor segment is substantially orthogonal to the first and second major segments. In yet another alternative embodiment (not shown), the minor segment is at obtuse angles with respect to the first and second major segments. In yet another alternative embodiment (not shown), the first major segment is at an acute angle with respect to the second major segment.

In the illustrated embodiment, the major segments have a substantially longer length the minor segment. Additionally, the first major segment has the same length as the second major segment. In an alternative embodiment (not shown), the first major segment has a different length from the second major segment.

With continued reference to FIG. 6A, the major segments of the segmented sipe have a thickness tₐ when the tire is at rest and the minor segment has a thickness t_{b} when the tire is at rest. In the illustrated embodiment, the thickness tₐ of the first major segment is substantially the same as the thickness of the second major segment. In the illustrated embodiment, the thickness t_{b} of the minor segment is less than the thickness tₐ of the major segments. In one embodiment, the thickness tₐ of each major segment is about 0.030 inches to about 0.060 inches and the thickness t_{b} of the minor segment is about 0.008 inches to about 0.025 inches.

In an alternative embodiment (not shown), the thickness t_{b} of the minor segment is equal to the thickness tₐ of the major segments. In another alternative embodiment (not shown), the thickness of the first major segment is different from the thickness of the second major segment.

In the illustrated embodiment, the minor segment and the first and second major segments are substantially straight. In an alternative embodiment (not shown), at least one of the segments is curved.

FIG. 7 illustrates one embodiment of the tread block 600 when a braking force F_{B} is applied. With the above described configuration, the tread block 600 is configured to deform when a braking force F_{B} is applied, such that the thickness of the radially segmented sipe 605 is substantially reduced. In the illustrated embodiment, when a braking force F_{B} is applied, a forward portion 710 of the tread block 600 deforms such that the first elongated wall 620 is moved towards the second elongated wall 625, reducing the thickness of the first major segment. Further, the first minor wall 640 is moved towards the second minor wall 645, thereby reducing the thickness of the minor segment.

In the illustrated embodiment, when a sufficient braking force F_{B} is applied to a tire, the first elongated wall 620 contacts the second elongated wall 625, substantially reducing the thickness of the first major segment to zero. In other words, the first major segment is eliminated Further, the first minor wall 640 contacts the second minor wall 645, substantially reducing the thickness of the minor segment to zero. In other words, the second minor segment is eliminated. It should be understood that when a lesser braking force is applied, the tread block 600 may be deformed such that the segments of the radially segmented sipe 605 are reduced, but not eliminated. Further, in an alternative embodiment (not shown), the tread block 600 may be sufficiently rigid such that the segments of the radially segmented sipe 605 are never eliminated, but merely reduced.

As a result of the above, the sipe opening in the top surface 615 closes, and the forward portion 655 of the top surface 615 is only slightly displaced with respect to the rearward portion 660 of the top surface 615. In one embodiment, the displacement of the forward portion 655 relative to the rearward portion 660 is equal to or less than the thickness t_{b} of the minor segment. Because the first minor wall 640 is contacting the second minor wall 645, the radially segmented sipe 605 is closed and the tread block 600 cannot be further deformed. In other words, the sipe is locked and the tread block 600 becomes rigid such that the forward portion 655 of the top surface 615 cannot be further displaced. Therefore, when a braking force is applied to a tire, more of the tread surface stays in contact with a road surface. This results in improved tire traction for braking, especially on a dry surface, thus reducing stopping distance.

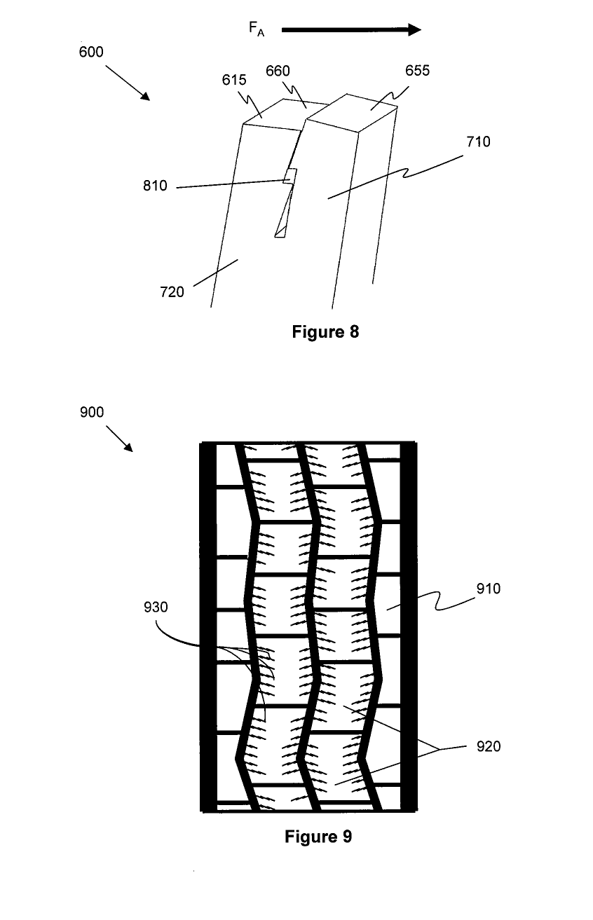

FIG. 8 illustrates one embodiment of the tread block 600 when an acceleration force F_{A} is applied. As can be seen in the illustrated embodiment, the rearward portion 720 of the tread block 600 deforms such that the second elongated wall 625 is moved towards the first elongated wall 620, reducing the thickness of the first major segment. Further, the fourth elongated wall 635 is moved towards the third elongated wall 630, reducing the thickness of the second major segment.

In the illustrated embodiment, when a sufficient acceleration force F_{A} is applied to a tire, the second elongated wall 625 contacts the first elongated wall 620, substantially reducing the thickness of the first major segment to zero. In other words, the first major segment is eliminated. It should be understood that when a lesser acceleration force is applied, the tread block 600 may be deformed such that the first major segment is reduced, but not eliminated. Further, in an alternative embodiment (not shown), the tread block 600 may be sufficiently rigid such that the first major segment is never eliminated, but merely reduced.

With continued reference to FIG. 8, the geometry of the radially segmented sipe 605 is such that when an acceleration force F_{A} is applied to the tread block 600, the tread block 600 is deformed such that the rearward portion 720 of the tread block 600 biases the forward portion 710 in a forward direction. Therefore, the first minor wall 640 and the second minor wall 645 move away from each other, increasing the thickness of the minor segment. In an alternative embodiment (not shown), the geometry of the sipe 600 may be such that the minor segment maintains the same thickness when an acceleration force is applied to a tire.

In the above described embodiment, when an acceleration force F_{A} is applied to a tire, the forward portion 655 of the top surface 615 is displaced relative to the rear portion 660. The sipe does not lock into position, so the tread block 600 has less rigidity when it is in an acceleration condition. When the acceleration force is increased, the tread block 600 is further deformed, and the displacement of the forward portion 655 is increased, thereby reducing the surface area of the tread that is exposed to a road surface. This results in improved tire traction for accelerating in snowy, wet, or other slippery conditions.

Although only radially segmented sipes having two and three major segments have been illustrated, it should be understood that in alternative embodiments (not shown), a segmented sipe may have four or more major segments. For example, in one embodiment (not shown), a radially segmented sipe may have four major segments and three minor segments. In another embodiment (not shown), a radially segmented sipe may have five major segments and four minor segments. In yet another embodiment, a radially segmented sipe may have n major segments and n-1 minor segments. It should also be understood that a tire may have sipes of varying length with a varying number of segments. For example, in one embodiment (not shown), half of the sipes of a tire may have two major segments and half of the sipes may have three major segments.

FIG. 9 illustrates one embodiment of a tire 900 having a circumferential tread 910 with a plurality of tread blocks 920. Each of the tread blocks 920 includes one or more laterally segmented sipes 930. The segments of the sipe are in a lateral direction. In other words, the sipes 930 have segmented openings as viewed from a top surface of the tire 900. In an alternative embodiment (not shown), a tire having a circumferential tread with a plurality of ribs includes one or more laterally segmented sipes disposed in the ribs, rather than blocks.

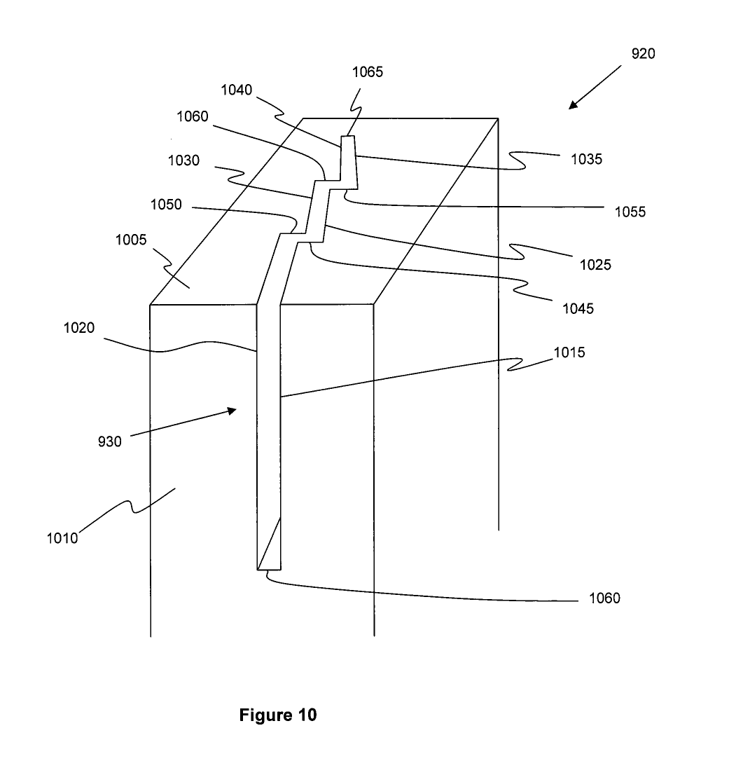

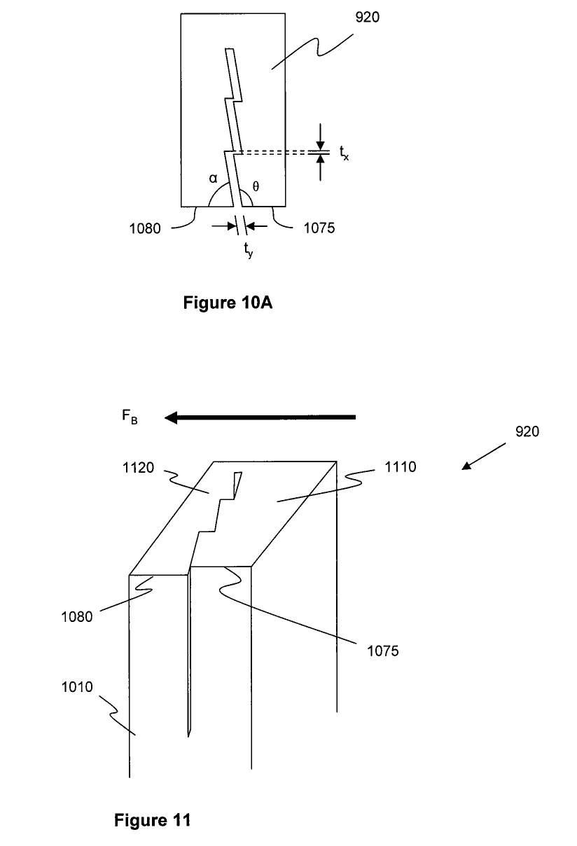

FIG. 10 illustrates a close up, perspective view of a tread block 920 having one embodiment of a laterally segmented sipe 930. The block 920 may be any regular or irregular polyhedron and includes at least a top surface 1005 defining a top surface of the circumferential tread 910 of the tire 900 and a side surface 1010 defining a groove in the circumferential tread 910. The laterally segmented sipe 930 is a void in the tread block 920 defined by a plurality of walls. In the illustrated embodiment, the laterally segmented sipe 930 is defined by a first elongated wall 1015 that extends radially inward from the top surface 1005 of the tread block 920, thereby forming an edge with the top surface 1005 and additionally forming an edge with the side surface 1010. The laterally segmented sipe 930 is further defined by a second elongated wall 1020 that extends radially inward from the top surface 1005 of the tread block 920, thereby forming an edge with the top surface 1005 and additionally forming an edge with the side surface 1010. The laterally segmented sipe 930 is further defined by a third elongated wall 1025, a fourth elongated wall 1030, a fifth elongated wall 1035, and a sixth elongated wall 1040, each of which extends radially inward from the top surface 1005 of the tread block 120 to form an edge with the top surface 1005.

Additionally, the laterally segmented sipe 930 is defined by a plurality of minor walls that connect the elongated walls, including a first minor wall 1045 extending from an end of the first elongated wall 1015 to the third elongated wall 1025; a second minor wall 1050 extending from an end of the second elongated wall 1020 to an end of the fourth elongated wall 1030; a third minor wall 1055 extending from an end of the third elongated wall 1025 to an end of the fifth elongated wall 1035; a fourth minor wall 1060 extending from an end of the fourth elongated wall 1030 to an end of the sixth elongated wall 1040; and a fifth minor wall 1065 extending from an end of the fifth elongated wall 1035 to an end of the sixth elongated wall 1040. As can be seen in FIG. 10, the elongated walls 1015, 1020, 1025, 1030, 1035, 1040 have a substantially longer length than the minor walls 1045, 1050, 1055, 1060, 1065. As shown in FIG. 10, the laterally segmented sipe is further defined by a bottom surface 1070.

In the illustrated embodiment, each of the elongated walls 1015, 1020, 1025, 1030, 1035, 1040 are substantially parallel to each other. Similarly, each of the minor walls 1045, 1050, 1055, 1060, 1065 are substantially parallel to each other. Additionally, each of the minor walls 1045, 1050, 1055, 1060, 1065 are substantially parallel to an equatorial plane of the tire and are at acute angles with respect to the elongated walls 1015, 1020, 1025, 1030, 1035, 1040. In an alternative embodiment (not shown), the elongated walls are at acute angles with respect to each other. In another alternative embodiment (not shown), the minor walls are at acute angles with respect to each other. In yet another alternative embodiment (not shown), the minor walls are at acute angles with respect to the equatorial plane of the tire.

With continued reference to FIG. 10, the laterally segmented sipe 930 may be described as having a segmented shape. Specifically, the sipe 930 may be described as having a “ratchet” or “lightning bolt” shape. In the illustrated embodiment, the laterally segmented sipe includes three major segments and two minor segments, each of which is visible when viewed from the top surface of the tread block 920. In the illustrated embodiment, the first and second elongated walls 1015, 1020 define a first major segment, the third and fourth elongated walls 1025, 1030 define a second major segment, and the fifth and sixth elongated walls 1035, 1040 define a third major segment. Further, the first and second minor walls 1045, 1050 define a first minor segment having a first end connected to an end of the first major segment and a second end connected to an end of the second major segment. In other words, the first minor segment extends from an end of the first major segment to an end of the second major segment. Additionally, the third and fourth minor walls 1055, 1060 define a second minor segment having a first end connected to an end of the second major segment and a second end connected to an end of the third major segment. In other words, the second minor segment extends from the second major segment to the third major segment.

FIG. 10A illustrates a top planar view of one embodiment of the tread block 920. As can be seen in the illustrated embodiment, the first, second, and third major segments are substantially parallel to each other. Further, the first minor segment is substantially parallel to the second minor segment. Additionally, the first and second minor segments are substantially parallel to the circumferential direction of the tire and are at acute angles with respect to the major segments. In an alternative embodiment (not shown), the first and second minor segments are substantially parallel to the side surface of the tread block. In another alternative embodiment (not shown), the first minor segment is at an acute angle with respect to the second minor segment. In yet another alternative embodiment (not shown), the first and second minor segments are substantially orthogonal to the major segments. In yet another alternative embodiment (not shown), the first and second minor segments are at obtuse angles with respect to the major segments. In yet another alternative embodiment (not shown), at least two of the major segments are at acute angles with respect to each other.

In the illustrated embodiment, the major segments have a substantially longer length than the minor segments. Additionally, the major segments each have substantially the same length. Similarly, the first minor segment has the same length as the second minor segment. In an alternative embodiment (not shown), at least one of the major segments has a different length from the other major segments. In another alternative embodiment (not shown), the first minor segment has a different length from the second minor segment.

When the tire is at rest, as shown in FIG. 10A, the minor segments have a thickness tₓ and the major segments of the laterally segmented sipe have a thickness t_{y}. In the illustrated embodiment, the thickness t_{y} of each major segment is substantially the same as the other major segments. Further, the thickness tₓ of the first minor segment is substantially the same as the thickness of the second minor segment. In the illustrated embodiment, the thickness tₓ of the minor segments is less than the thickness t_{y} of the major segments. In one embodiment, the thickness t_{y} of each major segment is about 0.030 inches to about 0.060 inches and the thickness tₓ of each minor segment is about 0.008 inches to about 0.025 inches.

In an alternative embodiment (not shown), the thickness tₓ of the minor segments is equal to the thickness t_{y} of the major segments. In another alternative embodiment (not shown), the thickness of at least one of the major segments is different from the thickness of another major segment. In another alternative embodiment (not shown), the thickness of the first minor segment is different from the thickness of the second minor segment. As can be seen in the illustrated embodiment, the first major segment forms an obtuse angle θ with a forward portion 1075 of the side surface 1010 of the tread block 920 and an acute angle α with a rearward portion 1080 of the side surface 1010 of the tread block 920.

FIG. 11 illustrates one embodiment of the tread block 920 when a braking force F_{B} is applied. With the above described configuration, the tread block 920 is configured to deform when a braking force is applied, such that the thickness of the sipe is substantially reduced. In the illustrated embodiment, a forward portion 1110 of the tread block 920 deforms and is biased towards a rearward portion 1120, such that the first elongated wall 1015 is moved towards the second elongated wall 1020, reducing the thickness of the first major segment. Further, the third elongated wall 1025 is moved towards the fourth elongated wall 1030, reducing the thickness of the second major segment. Additionally, the fifth elongated wall 1035 is moved towards the sixth elongated wall 1040, reducing the thickness of the third major segment.

With continued reference to FIG. 11, the geometry of the laterally segmented sipe 930 is such that when a braking force F_{B} is applied to a tread block 920, the tread block 920 is deformed such that the first minor wall 1045 is moved towards the second minor wall 1050, reducing the thickness of the first minor segment. Further, the third minor wall 1055 is moved towards the fourth minor wall 1060, reducing the thickness of the second minor segment.

In the illustrated embodiment, when a sufficient braking force F_{B} is applied to a tire, the first elongated wall 1015 contacts the second elongated wall 1020, substantially reducing the thickness of the first major segment to zero. In other words, the first major segment is eliminated. Similarly, the third elongated wall 1025 contacts the fourth elongated wall 1030, substantially reducing the thickness of the second major segment to zero. In other words, the second major segment is eliminated. Further, the first minor wall 1045 contacts the second minor wall 1050, substantially reducing the thickness of the first minor segment to zero. In other words, the first minor segment is eliminated. Similarly, the third minor wall 1055 contacts the fourth minor wall 1060, substantially reducing the thickness of the second minor segment to zero. In other words, the second minor segment is eliminated. It should be understood that when a lesser braking force is applied, the tread block 920 may be deformed such that the segments of the sipe 930 are reduced without being eliminated. Further, in an alternative embodiment (not shown), the tread block 920 may be sufficiently rigid such that the segments of the sipe 930 are never eliminated, but merely reduced.

As a result of the above, when a braking force is applied to a tire, the openings defining the sipe are greatly reduced, or in some cases even substantially eliminated. Therefore, more of the tread surface stays in contact with a road surface. This results in improved tire traction for braking, especially on a dry surface, thus reducing stopping distance.

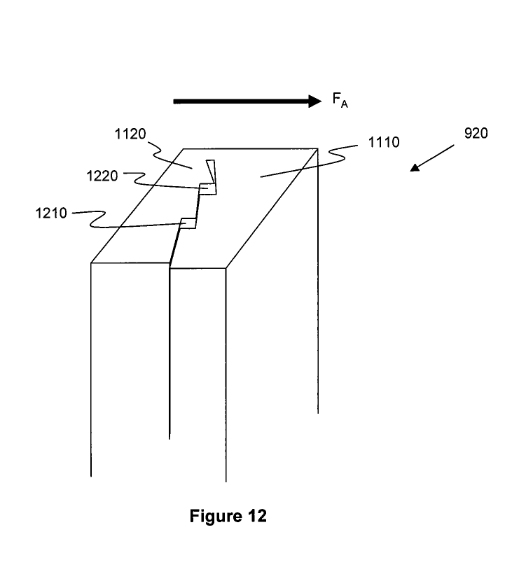

FIG. 12 illustrates one embodiment of the tread block 920 when an acceleration force F_{A} is applied to a tread block 920. The tread block 920 is configured to deform when an acceleration force is applied, such that the sipe is not eliminated. As can be seen in the illustrated embodiment, that rearward portion 1120 of the tread block 920 deforms and is biased towards the forward portion 1110 such that the second elongated wall 1020 is moved towards the first elongated wall 1015, reducing the thickness of the first major segment. Further, the fourth elongated wall 1030 is moved towards the third elongated wall 1025, reducing the thickness of the second major segment. Additionally, the sixth elongated wall 1040 is moved towards the fifth elongated wall 1035, reducing the thickness of the first major segment.

With continued reference to FIG. 12, the geometry of the laterally segmented sipe 930 is such that when an acceleration force F_{A} is applied to a tread block 920, the tread block 920 is deformed such that the first minor wall 1045 and the second minor wall 1050 move away from each other, increasing the thickness of the first minor segment and creating a first enlarged opening 1210. Further, the third minor wall 1055 and the fourth minor wall 1060 move away from each other, increasing the thickness of the second minor segment and creating a second enlarged opening 1220. In an alternative embodiment (not shown), the geometry of the sipe 930 may be such that the minor segments maintain the same thickness when an acceleration force is applied to a tire.

In the illustrated embodiment, when a sufficient acceleration force F_{A} is applied to a tire, the second elongated wall 1020 contacts the first elongated wall 1015, substantially reducing the thickness of the first major segment to zero. Similarly, the third elongated wall 1030 contacts the fourth elongated wall 1025, substantially reducing the thickness of the second major segment to zero. It should be understood that when a lesser acceleration force is applied, the tread block 920 may be deformed such that the elongated segments of the sipe 930 are reduced, but not eliminated. Further, in an alternative embodiment (not shown), the tread block 920 may be sufficiently rigid such that the elongated segments of the sipe 930 are never eliminated, but merely reduced.

In the above described embodiment, when an acceleration force F_{A} is applied to a tire, the first and second enlarged openings 1210, 1220 create sipe edges that remain exposed to a road surface. This results in improved tire traction for accelerating in snowy, wet, or other slippery conditions.

Although only laterally segmented sipes having three major segments have been illustrated, it should be understood that in an alternative embodiment (not shown), a laterally segmented sipe may have two major segments and one minor segment. In other alternative embodiments (not shown), a laterally segmented sipe may have four or more major segments. For example, in one embodiment (not shown), a laterally segmented sipe may have four major segments and three minor segments. In another embodiment (not shown), a laterally segmented sipe may have five major segments and four minor segments. In yet another embodiment, a laterally segmented sipe may have n major segments and n-1 minor segments. It should also be understood that a tire may have sipes of varying length with a varying number of segments. For example, in one embodiment (not shown), half of the sipes of a tire may have two major segments and half of the sipes may have three major segments.

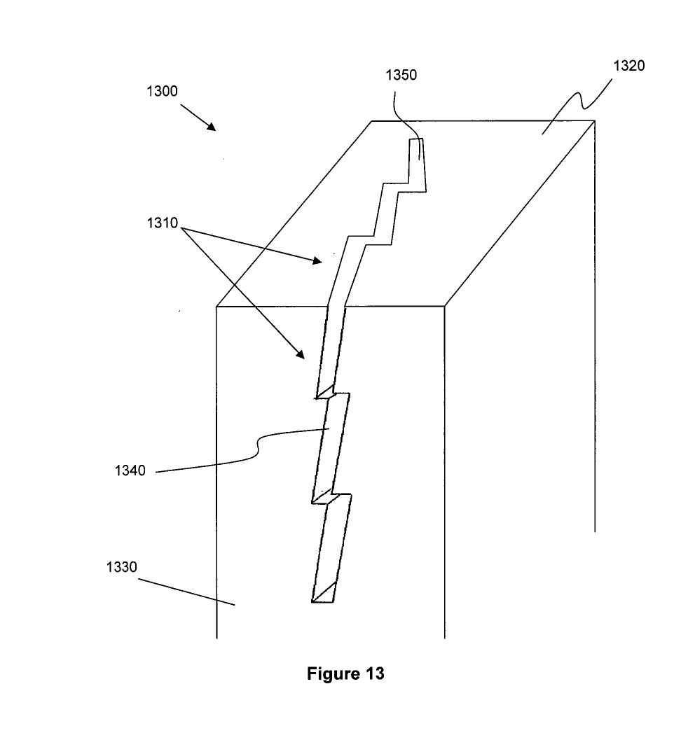

FIG. 13 illustrates a perspective view of a tread block 1300 having a segmented sipe 1310 that is segmented two directions. The tread block 1300 may be any regular or irregular polyhedron and includes at least a top surface 1320 defining a top surface of a circumferential tread of a tire, and a side surface 1330 defining a groove in the circumferential tread. The segmented sipe 1310 includes a radially segmented portion 1340 defined by a plurality of elongated walls and minor walls similar to the various embodiments of laterally segmented sipes 305, 605 described above in relation to FIGS. 3-8. The segmented sipe 1310 further includes a laterally segmented portion 1350 defined by a plurality of elongated walls and minor walls similar to the various embodiments of laterally segmented sipes 930 described above in relation to FIGS. 9-12.

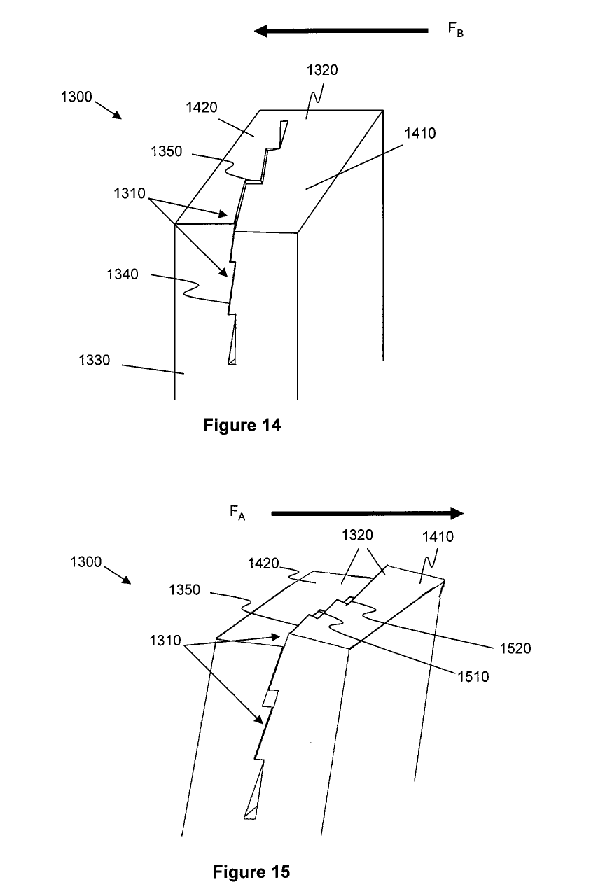

FIG. 14 illustrates a perspective view of the tread block 1300 having a sipe 1310 segmented in two directions, under a braking condition. The geometry of the segmented sipe 1310 will cause the tread block to deform when a braking force F_{B} is applied, as described above in relation to FIGS. 4, 7, and 11. In other words, the sipe opening in the top surface 1320 closes, and a forward portion 1410 of the top surface 1320 is only slightly displaced with respect to a rearward portion 1420 of the top surface 1320. Because the minor walls of the radially segmented portion 1330 are contacting each other, as describe above in FIGS. 4 and 7, the radially segmented portion 1330 is closed and the tread block 1300 cannot be further deformed. In other words, the sipe is locked and the tread block 1300 becomes rigid such that the forward portion 1410 of the top surface 1320 cannot be further displaced. Because the tread block 1300 is more rigid and because the sipe openings in the top surface 1320 are substantially eliminated when a braking force is applied to a tire, more of the tread surface stays in contact with a road surface. This results in improved tire traction for braking, especially on a dry surface, thus reducing stopping distance.

FIG. 15 illustrates a perspective view of the tread block 1300 having a sipe 1310 segmented in two directions, under an acceleration condition. The geometry of the segmented sipe 1310 will cause the tread block to deform when an acceleration force F_{A} is applied, as described above in relation to FIGS. 5, 8, and 12. In other words, when an acceleration force F_{A} is applied to a tire, the forward portion 1410 of the top surface 1320 is displaced relative to the rear portion 1420. The sipe does not lock into position, so the tread block 1300 has less rigidity when it is in an acceleration condition. When the acceleration force is increased, the tread block 1300 is further deformed, and the displacement of the forward portion 1410 is increased, thereby reducing the surface area of the tread that is exposed to a road surface. Additionally, when an acceleration force F_{A} is applied to a tire, first and second enlarged openings 1510, 1520 in the laterally segmented portion 1350 are created, resulting in additional edges exposed to a road surface. This results in improved tire traction for accelerating in snowy, wet, or other slippery conditions.

The tires and tread blocks described above and illustrated in FIGS. 1-15 can be produced in a variety of ways. One exemplary production method includes the use of a tire vulcanization mold. The mold includes tread imparting structure configured to form a tread onto a green tire being molded. The tread imparting structure can include one or more sipe-forming elements. In one embodiment, the tread imparting structure includes one or more blades that protrude outward from a base surface.

In various embodiments, the sipe forming elements have segmented shapes corresponding to the sipes described in the embodiments above. For example, in one embodiment, at least one of the sipe forming elements has a plurality of segments including at least a first major segment, a second major segment, and a minor segment extending from one end of the first major segment of the sipe forming element to one end of the second major segment. In another embodiment, at least one of the sipe forming elements further includes a third major segment and a second minor segment extending from one end of second major segment to one end of the third major segment. In yet another embodiment, at least one of the sipe forming elements includes n major segments and n-1 minor segments.

The sipe forming elements can be arranged at certain intervals along the tire. The sipe forming elements can be provided in the mold in a variety of ways. For example, the sipe forming element can be formed as a separate component that can be inserted into the mold and secured thereto via pins. Other means to secure the sipe forming element to the mold are possible and known in the art. Alternatively, the sipe forming element can be an integral part of the mold (e.g., formed directly in the mold during casting of the mold).

To produce the tire in the mold, a green tire is first placed in the mold. To support the green tire during the molding process, a high temperature and high pressure medium is charged into a bladder (not shown). As the mold is collapsed around the green tire, the tread imparting structure is forced into the green tire. In this manner, the circumferential frame segments form one or more circumferential grooves in the outer surface of the tread of the tire. In this same manner, the sipe forming elements are forced into the green tire, thereby forming concave recesses in the outer surface of the tread of the tire.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's claimed invention.

1. A tire having an equatorial plane and a circumferential tread, the tire comprising:
at least one tread block having a sipe, the sipe having at least three segments, including a first major segment, a second major segment, and a minor segment having a first end connected to the first major segment and a second end connected to the second major segment, such that the first major segment and second major segment extend in a substantially radial direction and the minor segment is substantially parallel to a top surface of the tread block.

2. The tire of claim 1, wherein the first major segment is substantially parallel to the second major segment.

3. The tire of claim 2, wherein the first major segment forms an obtuse angle with a forward portion of the top surface of the tread block and an acute angle with a rearward portion of the top surface of the tread block.

4. The tire of claim 1, wherein each of the first major segment, the second major segment, and the minor segment is a linear segment.

5. The tire of claim 1, wherein the sipe further includes a third major segment and a second minor segment having a first end connected to the second major segment and a second end connected to the third major segment.

6. The tire of claim 5, wherein the first major segment forms an obtuse angle with a forward portion of the top surface of the tread block.

7. The tire of claim 6, wherein the first major segment is substantially parallel to the second major segment and to the third major segment.

8. The tire of claim 1, wherein the tread block is configured to deform when a braking force is applied to the tread block, such that a thickness of the sipe is substantially reduced.

9. The tire of claim 1, wherein the tread block is configured to deform when an acceleration force is applied to the tread block, such that a thickness of the first major segment is reduced and a thickness of the minor segment is enlarged.

10. A tire tread comprising:
at least one tread block having a plurality of spaced apart, radial walls that define a sipe, the plurality of spaced apart, radial walls including
a first elongated wall that forms an edge with a top surface of the tread block and forms an edge with a side surface of the tread block,
a second elongated wall that is substantially parallel to the first elongated wall and forms an edge with a side surface of the tread block,
a third elongated wall that forms an edge with a top surface of the tread block,
a fourth elongated wall that is substantially parallel to the third elongated wall,
a first minor wall that forms an edge with a top surface of the tread block, forms an edge with the first elongated wall, and forms an edge with the third elongated wall, and
a second minor wall that is substantially parallel to the first minor wall, forms an edge with the top surface of the tread block, forms an edge with the second elongated wall, and forms an edge with the fourth elongated wall.

11. The tire tread of claim 10, wherein the first minor wall and the second minor wall are substantially parallel to an equatorial plane of the tire.

12. The tire tread of claim 10, wherein the first elongated wall forms an obtuse angle with the side of the tread block.

13. The tire tread of claim 10, wherein the second elongated wall forms an acute angle with the side of the tread block.

14. The tire tread of claim 10, wherein each of the first elongated wall, the second elongated wall, the third elongated wall, and the fourth elongated wall is longer than the first minor wall and the second minor wall.

15. The tire tread of claim 10, further comprising a fifth elongated wall that forms an edge with a top surface of the tread block; a sixth elongated wall that is substantially parallel to the fifth elongated wall; a third minor wall that forms an edge with the top surface of the tread block, forms an edge with the third elongated wall, and forms an edge with the fifth elongated wall; and a fourth minor wall that is substantially parallel to the third minor wall, forms an edge with the top surface of the tread block, forms an edge with the fourth elongated wall, and forms an edge with the sixth elongated wall.

16. The tire tread of claim 10, wherein the tread block is configured to deform when a braking force is applied to the tire tread, such that the first elongated wall moves towards the second elongated wall.

17. The tire tread of claim 10, wherein the tread block is configured to deform when an acceleration force is applied to the tire tread, such that the second minor wall moves away from the first minor wall.

18. A vulcanization mold for the production of a tire, the mold comprising:
a mold housing having tread imparting structure configured to form a tread in a green tire;
the tread imparting structure having at least one blade configured to create a sipe in the tread of the green tire, the blade having a plurality of segments including at least a first major segment, a second major segment, and a minor segment extending from one end of the first major segment of the blade to one end of the second major segment.

19. The vulcanization mold of claim 18, wherein the tread imparting structure further includes a third major segment and a second minor segment extending from one end of second major segment to one end of the third major segment.

20. The vulcanization mold of claim 19, wherein the minor segment is parallel to the second minor segment.
